(19) United States
(12) Patent Application Publication
(10) Pub. No.: US 2012/0294496 A1
(43) Pub. Date: Nov. 22, 2012

(54) FACE RECOGNITION APPARATUS, CONTROL METHOD THEREOF, AND FACE RECOGNITION METHOD

(75) Inventor: Keishiro Nakamoto, Yokohama-shi (JP)

(73) Assignee: CANON KABUSHIKI KAISHA, Tokyo (JP)

(21) Appl. No.: 13/461,254

(22) Filed: May 1, 2012

(30) Foreign Application Priority Data
May 16, 2011 (JP) 2011-109412

(51) Int. Cl. G06K 9/62

(52) U.S. Cl. 382/118

(57) ABSTRACT

A degree of similarity is calculated by comparing registration face images of a person registered in a face dictionary with face images included in stored images, and the face image in which the calculated degree of similarity falls within a predetermined range where the calculated degree of similarity is not excessively high is extracted from a face image list. The extracted image is registered in a face dictionary, whereby easily producing the face dictionary that can efficiently retrieve the person from many images.

### BACKGROUND OF THE INVENTION

1. Field of the Invention

The present invention relates to a face recognition apparatus, control method thereof and face recognition method, for discriminating a person in an image using a face recognition function.

2. Description of the Related Art

A function of automatically managing images on each person basis by a face recognition function provided in an image browser is in widespread use. However, it is necessary to repeatedly register a face image in order to register the plurality of face images of the same person in a face dictionary.

For example, in Japanese Patent Application Laid-Open No. 2005-174308, a method of sorting face images assumed to be those of the same person as the initially-registered person in order of similarity by the face recognition function and presenting a list of the sorted images to a user is proposed in order to reduce work to register the face image in the face dictionary. The user selects the face image of such a person from the presented face image list, decides that the selected face image is that of the person oneself, and the image browser additionally registers the face image in the face dictionary. The face dictionary is updated at a time the face image is additionally registered, and the list of face images assumed to be those of the same person is presented again to the user as a result of the face recognition with higher accuracy.

In addition, a characteristic of the face recognition function is well known that the recognition accuracy is only slightly enhanced when the similar face images are registered.

As described above, the recognition accuracy cannot efficiently be improved even if the face image of the same person having the significantly high degree of similarity is newly registered with respect to the face image already registered in the face dictionary. Preferably, in order to efficiently improve the recognition accuracy, the face images of the same person, which are not so similar to each other are rather registered in the face dictionary.

However, it takes a long time to retrieve the face images of the same person, which are not so similar to each other, as the face image to be registered in the face dictionary. The user who does not know that the recognition accuracy is efficiently improved by registering the face images of the same person, which are not so similar to each other, in the face dictionary possibly may not retrieve even the face images of the same person, which are not so similar to each other.

### SUMMARY OF THE INVENTION

An aspect of the present invention is to solve all or at least one of the problems.

According to an aspect of the present invention, a face recognition apparatus comprises: a feature amount extraction unit configured to extract a face feature amount by analyzing a face image of a person in a picture image; a face dictionary generation unit configured to generate a face dictionary while relating the feature amount extracted by the feature amount extraction unit to a person's name; an addition unit configured to newly add a face feature amount while relating the face feature amount to a person's name registered in the face dictionary; and a display control unit configured to calculate a degree of similarity by comparing the face feature amount, which is extracted by analyzing the face image of the person in another picture image, with the face feature amount registered in the face dictionary, and to display the face image in which the degree of similarity falls within a predetermined range, as a candidate to be added to the face dictionary on a display portion.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating a personal computer according to an embodiment.

FIG. 2 is a view illustrating a face retrieve dialog according to the embodiment.

FIG. 3 is a view illustrating a face dictionary editing subject person selecting dialog according to the embodiment.

FIG. 4 is a view illustrating a face dictionary dialog and a face candidate image listing dialog according to the embodiment.

FIG. 5 is a view illustrating a configuration of a face image list according to the embodiment.

FIG. 6 is a view illustrating a configuration of a face dictionary according to the embodiment.

FIG. 7 is a flowchart of face dictionary registration image candidate extraction processing according to a first embodiment.

FIG. 8 is a view illustrating a detailed flowchart of recognition accuracy improving face image extraction processing according to the first embodiment.

FIG. 9 is a view illustrating an operation example of a face retrieve dialog, preceding to face image addition according to an embodiment.

FIG. 10 is a view illustrating operation examples of the face dictionary dialog and the face candidate image listing dialog according to the embodiment.

FIG. 11 is a view illustrating an operation example of a face retrieve dialog after the face image addition according to the embodiment.

FIG. 12 is a view illustrating a detailed flowchart of recognition accuracy improving face image extraction processing according to a modification of the first embodiment.

FIG. 13 is a view illustrating a detailed flowchart of recognition accuracy improving face image extraction processing according to another modification of the first embodiment.

FIG. 14 is a view illustrating a detailed flowchart of recognition accuracy improving face image extraction processing according to another modification of the first embodiment.

FIG. 15 is a view illustrating a detailed flowchart of recognition accuracy improving face image extraction processing according to another modification of the first embodiment.

FIG. 16 is a view illustrating a detailed flowchart of recognition accuracy improving face image extraction processing according to a second embodiment.

FIG. 17 is a view illustrating a face dictionary dialog and a face candidate image listing dialog according to the second embodiment.

FIG. 18 is a view illustrating a face dictionary dialog and a face candidate image listing dialog according to a modification of the second embodiment.

### DESCRIPTION OF THE EMBODIMENTS

Various exemplary embodiments, features, and aspects of the invention will be described in detail below with reference to the drawings.

### First Embodiment

In the following embodiments, an image browser is an application having functions of managing an image file, displaying an image, and displaying a list of thumbnail images belonging to the image file. In the following embodiments, a face of a person of the image is analyzed to parameterize the features such as a shape and a color of eyes, a nose, a mouth, and a face through a predetermined operation is referred to as a “face feature amount”.

A database file in which a data base of information on the face feature amount is manageably formed using a number or a file name is referred to as a “face dictionary”.

A face recognition apparatus of the present embodiment includes a function of recognizing a face included in the image of the image file in a storage device such as a hard disk and managing the face on the each person basis. A face recognition apparatus that displays a list of a face image candidate to a user, which candidate may efficiently improve recognition accuracy in registering the face in the face dictionary will be described in a first embodiment.

### Image Browser Operated as Face Recognition Apparatus

A personal computer that is operated as a face recognition apparatus according to an embodiment of the invention will be described.

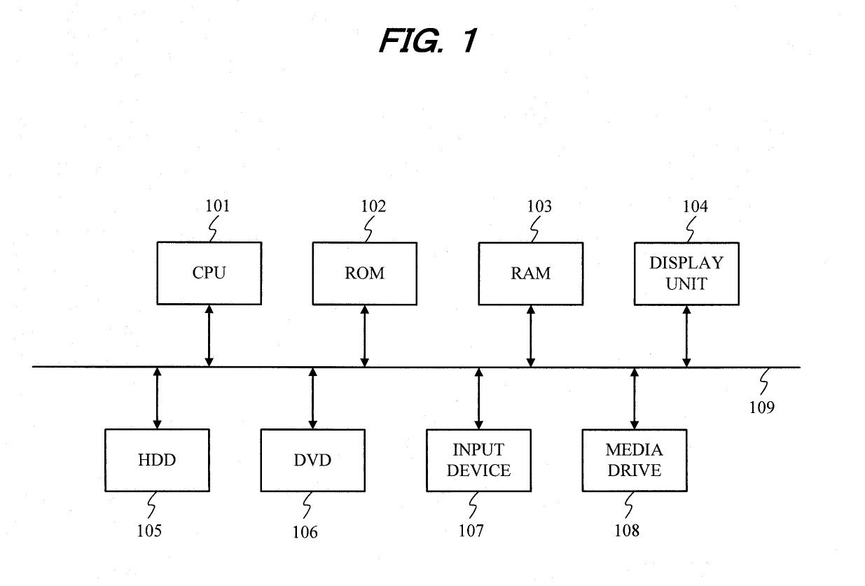

FIG. 1 is a block diagram illustrating the personal computer according to the present embodiment of the invention. The personal computer performs the following face recognition processing by executing a predetermined control program in the personal computer, and the personal computer functions as the face recognition apparatus.

Referring to FIG. 1, a Central Processing Unit (CPU) 101 controls the whole personal computer. An operation processing procedure (such as a program for processing in turning on a power of the personal computer and a program for basic input/output processing) of the CPU 101 is stored in a Read Only Memory (ROM) 102. A Random Access Memory (RAM) 103 functions as a main memory of the CPU 101. The RAM 103 provides a work area in performing various processings including a control program executing the later-described processing. A display unit 104 performs various kinds of display under the control of the CPU 101. For example, the display unit 104 displays thumbnails in a listing manner using the application of the image browser. The control program of the image browser is stored in a hard disk drive 105. The image file and face dictionary that are managed by the image browser are also stored in the hard disk drive 105. A detachable optical recording medium can be attached on a DVD (Digital Versatile Disc) 106 to read data recorded in the optical recording medium. An input device 107 is a mouse and a keyboard that perform various manipulations of the image browser. A detachable recording medium can be attached on a recording medium loading unit (media drive) 108 to record the data or read the recorded data. A system bus (including an address bus, a data bus, and a control bus) 109 connects the above units.

### User Interface of Face Recognition Apparatus

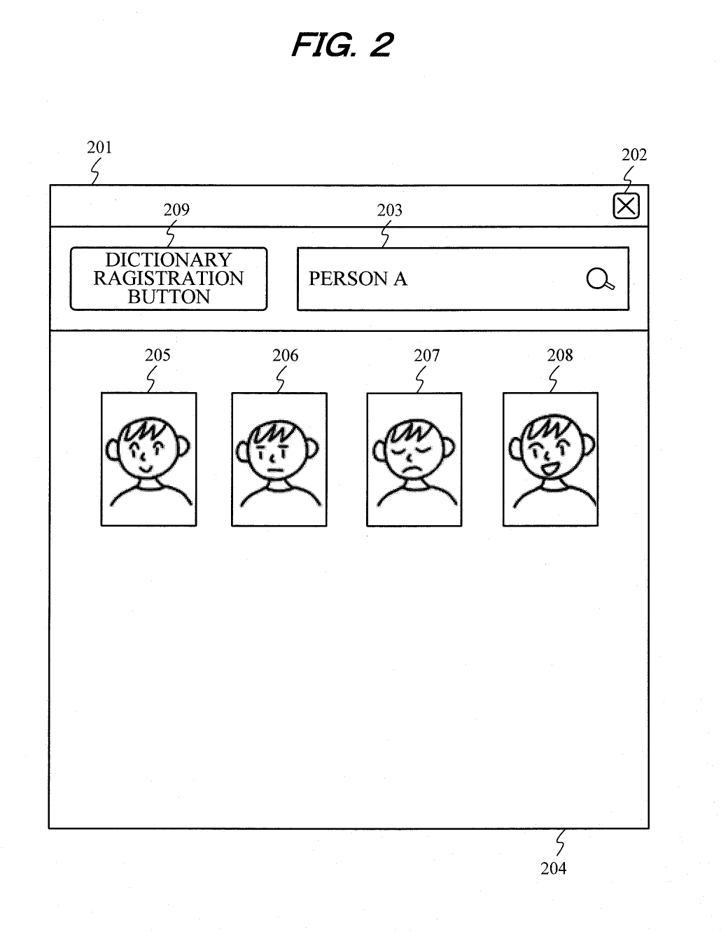

A user interface of the image browser that is operated as the face recognition apparatus according to the present embodiment of the invention will be described in detail with reference to FIGS. 2, 3, and 4. Generally, in addition to a function of displaying a list of images retained in a specific folder, the image browser also has a function of managing date and time of a picture image and a function of managing according to a site of the picture image. In the first embodiment, a face recognition function among the functions which the image browser of the invention has will be described below.

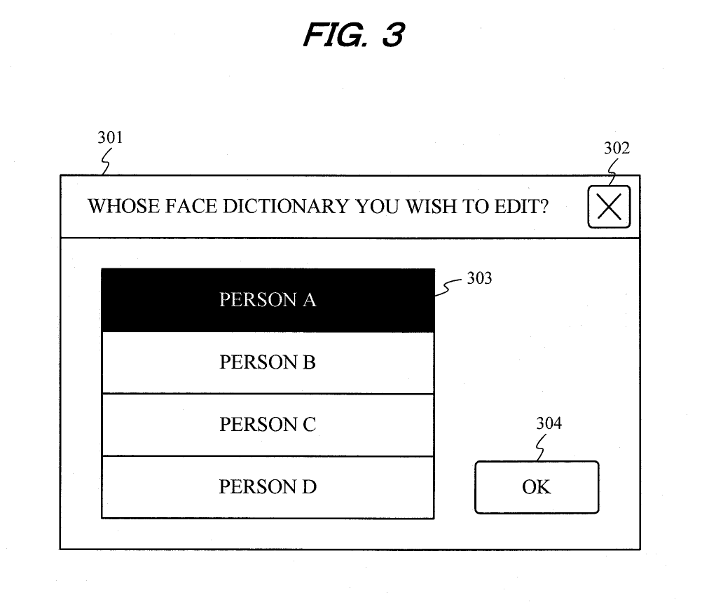

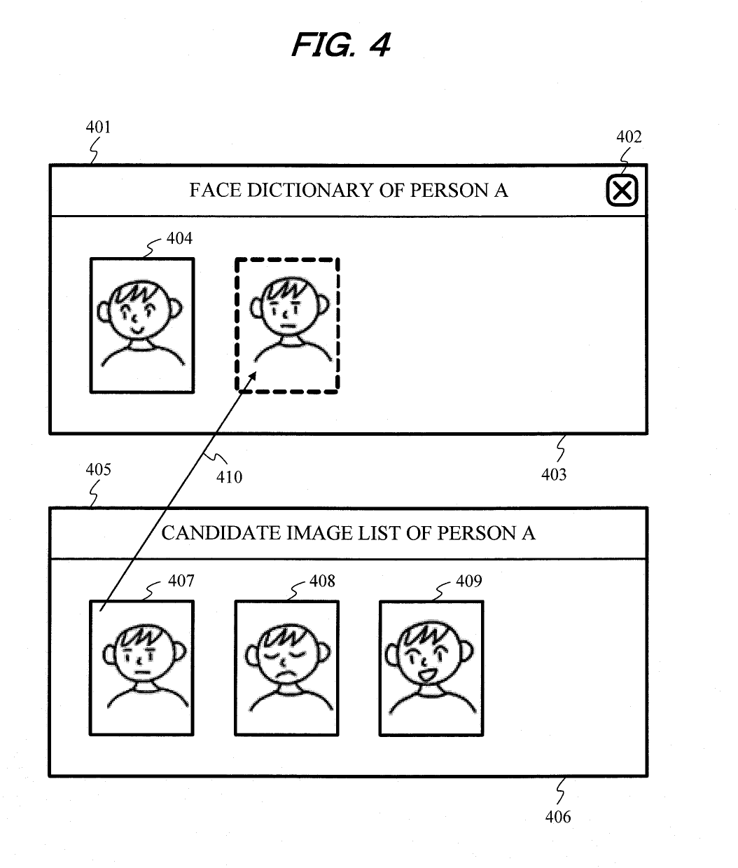

FIG. 2 is a view illustrating a face retrieve dialog according to the present embodiment of the invention. FIG. 3 is a view illustrating a face dictionary editing subject person selecting dialog according to the present embodiment of the invention. FIG. 4 is a view illustrating a face dictionary dialog and a face candidate image listing dialog according to the embodiment of the invention.

The CPU 101 displays a face retrieve dialog 201 on the display 104 of the personal computer. When the user depresses an end button 202 of the face retrieve dialog, the CPU 101 ends the face retrieve dialog in the image browser. The reference numeral 203 denotes a person's name text box. The reference numeral 204 denotes a face image listing display area in the face retrieve dialog. When a person's name is input to a person's name text box 203 to issue an instruction to perform a retrieve command, the CPU 101 obtains the person's name input to the person's name text box 203. All of images (face dictionary registration images) decided by the user as image which includes therein an image of that person and images (for example, an image having a degree of similarity of a predetermined value or more) that are determined by the CPU 101 to be images including an image of a person similar to that person are displayed from a specific folder in the hard disk on the face image listing display area 204. The reference numeral 209 denotes a dictionary registration button. When the user depresses the dictionary registration button 209, the CPU 101 displays a face dictionary editing subject person selecting dialog 301 in FIG. 3.

The reference numeral 301 denotes a face dictionary editing subject person selecting dialog. When the user depresses an end button 302, the CPU 101 closes the face dictionary editing subject person selecting dialog 301 to transition to the face retrieve dialog 201. The reference numeral 303 denotes a face dictionary editing subject person selecting list box. At the time the dictionary registration button 209 is depressed to display the face dictionary editing subject person selecting dialog 301, the CPU 101 obtains a list of all the person's names already registered in the face dictionary from the face dictionary, and displays the list in the face dictionary editing subject person selecting list box 303. When the user manipulates the mouse to select a specific person in the persons displayed in the face dictionary editing subject person selecting list box 303, the CPU 101 changes a display state of the selected person's name to a state indicative of selection (reverse display in FIG. 3). The reference numeral 304 denotes an OK button of the face dictionary editing subject person selecting dialog 301. When the user depresses the OK button 304, the CPU 101 obtains the person's name that is in the state indicative of selection in the face dictionary editing subject person selecting list box 303, and closes the face dictionary editing subject person selecting dialog. The CPU 101 displays a face dictionary dialog 401 and a face candidate image listing dialog 405, which correspond to the obtained person's name.

The reference numeral 402 is an end button. When the user depresses the end button 402, the CPU 101 closes the face dictionary dialog 401 and the face candidate image listing dialog 405 to transition to the face retrieve dialog 201. The reference numeral 403 denotes a face dictionary registered image listing display area in the face dictionary dialog 401. The CPU 101 obtains the face images, which are already registered in the face dictionary by the user with respect to the selected specific person, from the face dictionary and displays the list of face images in the face dictionary registered image listing display area 403. By way of example, in FIG. 4, a face image 404 is displayed as a face of a person A that is obtained from the face dictionary by the CPU 101. The reference numeral 406 denotes a face candidate image listing display area. The CPU 101 obtains the face images, which are determined by the CPU 101 to be similar to the specific person assigned by the user, from the HDD 105 and displays the list of face images in the face candidate image listing display area 406. By way of example, in FIG. 4, a face image 407, a face image 408, and a face image 409 are displayed as a face candidate image obtained from the HDD 105 by the CPU 101.

In the case that the user visually recognizes that the face image 407 displayed in the face candidate image listing display area 406 is of the subject person oneself and registers the face image 407 in the face dictionary, the user selects the face image 407 using the mouse to perform a manipulation of drag and drop 410 to the face dictionary registered image listing area 403. In response to the manipulation of drag and drop 410 by the user, the CPU 101 registers the face of the face image 407 as the face of the person's name selected by the face dictionary editing subject person selecting dialog 303 in the face dictionary (face dictionary generation).

### Configuration of Face Image List

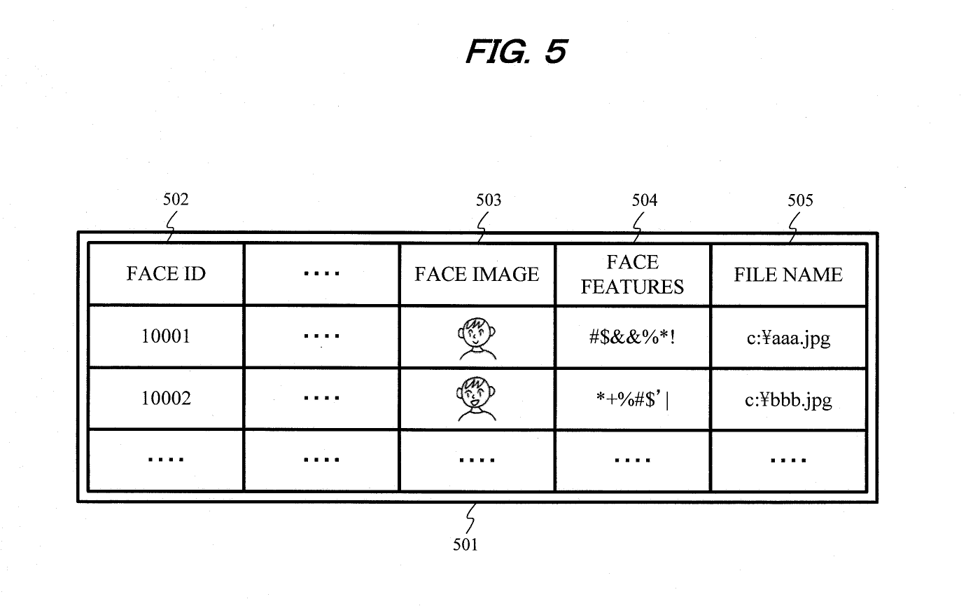

A configuration of a face image list according to the embodiment of the invention will be described with reference to FIG. 5.

In FIG. 5, a face image list 501 retains the faces included in all the images stored in a specific folder of the HDD 105 and information related to the faces. A face ID (face identifier) 502 is a unique number allocated in order to identify a person in a picture image in the HDD 105. The reference numeral 503 denotes a face image as a thumbnail, a region of a face portion of the person included in the image in the HDD 105, which corresponds to the face ID 502, is normalized into a specific size (in FIG. 5, a size of 120 pixels in vertical and 96 pixels in horizontal). The CPU 101 uses the face image 503 in displaying the face image in the face dictionary dialog 401 and the face candidate image listing display area 406. A face feature amount 504 is stored as the binary data in the face image list 501. The face feature amount 504 means the binary data in which the CPU 101 analyzes the face of the person included in the image to parameterize the shape of the eyes, the nose, the mouth, or the face. The reference numeral 505 denotes a file name of the image including the face of the face ID 502. That is, the face of the face ID 502 is in the image of this file name.

It is assumed that the information in the face image list 501 is the information that is generated by the CPU 101 by previously analyzing all the images in the specific folder based on the information on the specific folder that is set to the image browser as a retrieve target range folder by the user.

### Configuration of Face Dictionary

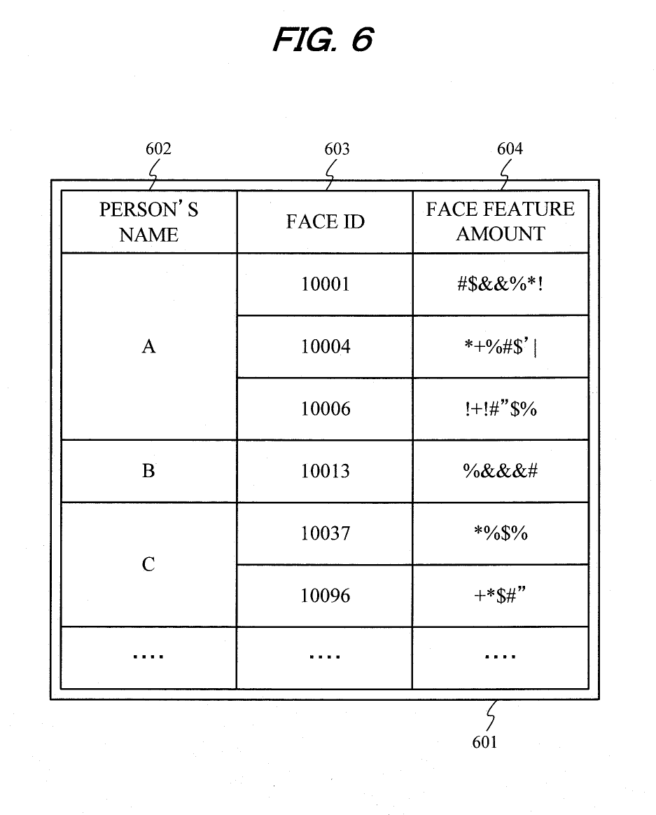

FIG. 6 is a view illustrating a configuration of the face dictionary according to the embodiment of the invention.

A face dictionary table 601 is retained in the HDD 105 in order that the CPU 101 manages the face information. The reference numeral 602 denotes a column of the person's name. When the user registers the person's name of the management target in the face dictionary, the CPU 101 records the person's name of the management target in the column of the person's name 602 of the face dictionary table 601. The reference numeral 603 denotes a column of the face ID. When the user registers the face ID 502 of the management target in the face dictionary, the CPU 101 records the face ID 502 of the management target in the column of the face ID 603 of the face dictionary table 601. The reference numeral 604 denotes a column of the face feature amount. When the user registers the face of the face ID 502 managed by the face image list 501 in the face dictionary, the CPU 101 records the face feature amount 504 of the face ID 502 in the column of the face feature amount 604 of the face dictionary table 601.

For one person's name 602 in the columns of the person's names 602, a plurality of face IDs 502 and the face feature amounts 504 therefor are grouped together.

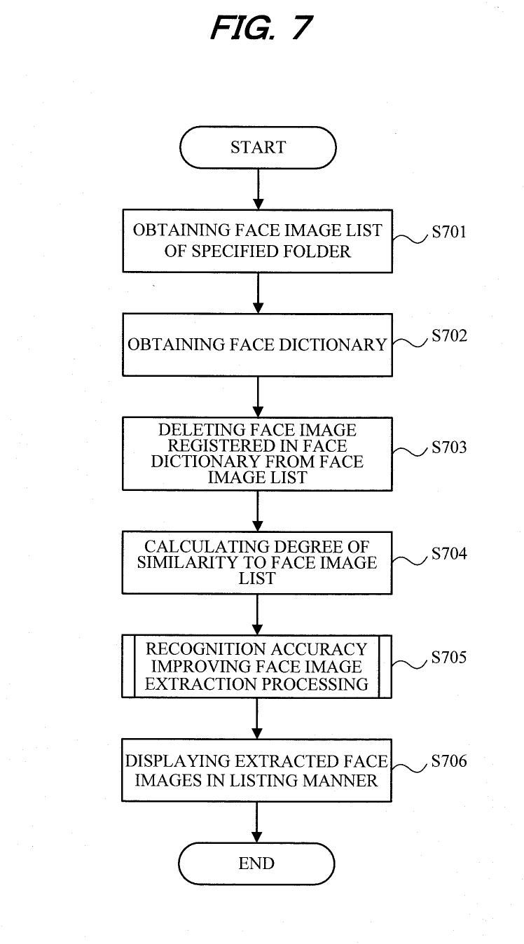

FIG. 7 is a flowchart of face dictionary registration image candidate extraction processing according to a first embodiment of the invention. The flowchart in FIG. 7 illustrates processing performed by the CPU 101 when the user opens the face candidate image listing dialog 405.

In Step S701, the CPU 101 copies the face image list 501 of the previously-produced specific folder from the HDD 501 to the memory. In Step S702, the CPU 101 obtains the person's name 602 to be subjected to retrieve and the face ID 603 and face feature amount 604, which are related to the person's name 602, from the face dictionary 601 existing in the HDD in accordance with a person's name selected in the face dictionary editing subject person selecting list box 303 (feature amount extraction). In Step S703, the CPU 101 deletes the face image having the same face ID 603 as the face image already registered in the face dictionary obtained in Step S702 from the copied face image list. In Step S704, the CPU 101 calculates the degree of similarity by comparing the face feature amount 604 of the face dictionary with each face feature amount 504 in the face image list. The calculated degree of similarity is retained by the CPU 101 in relation to the face ID in the face image list. In the case that a plurality of face IDs and a plurality of face feature amounts are related to the person's name of the retrieve target in the face dictionary, the CPU 101 merges the plurality of face feature amounts of the face dictionary, and compares the merged face feature amount with the face feature amount in the face image list to calculate the degree of similarity. In Step S705, the CPU 101 performs the recognition accuracy improving face image extraction processing of extracting the face image that efficiently improves the recognition accuracy. The detailed processing in Step S705 is described later.

In Step S706, the CPU 101 displays the list of face images extracted in Step S706 as the candidate image on the display screen, and ends the flowchart.

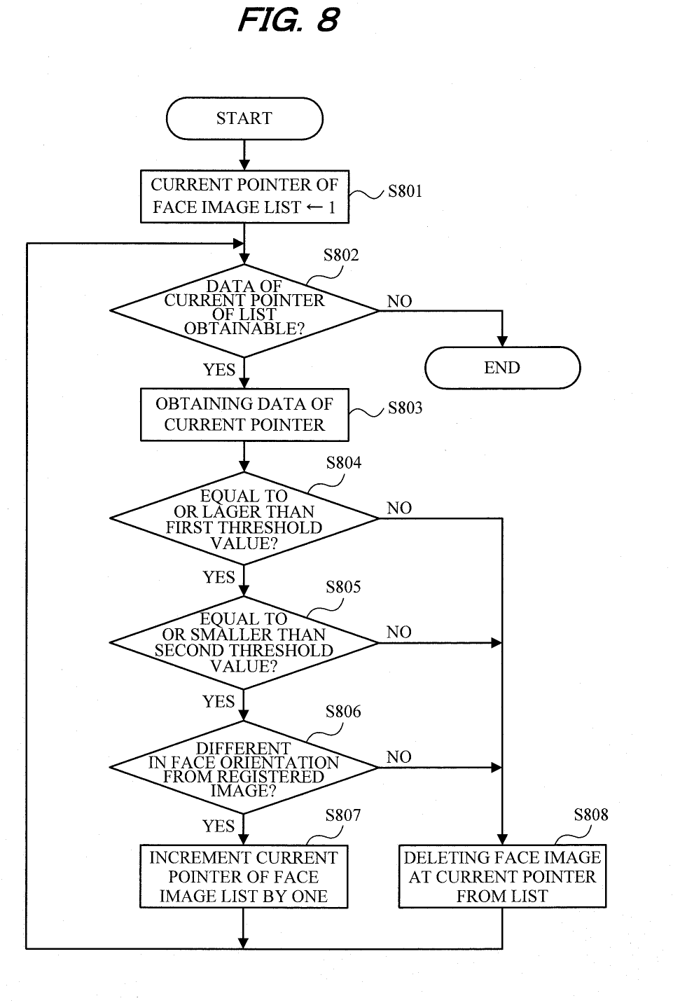

FIG. 8 is a view illustrating a detailed flowchart of recognition accuracy improving face image extraction processing according to the first embodiment of the invention. The flowchart in FIG. 8 describes the detailed recognition accuracy improving face image extraction processing in Step S705.

In Step S801, the CPU 101 moves a current pointer of the face image list to a head of the face image list (first in FIG. 8). In Step S802, the CPU 101 determines whether the data can be obtained from the current pointer of the face image list. When the data can be obtained from the current pointer of the face image list, the flow goes to processing in Step S803. When the data cannot be obtained from the current pointer of the face image list in Step S802, the CPU 101 ends the flowchart. In Step S803, the CPU 101 obtains the data of the current pointer of the face image list. In this case, not only the data of the face image list, but also the data of the degree of similarity, which is calculated in Step S704 and retained in relation to the face ID, are obtained. In Step S804, the CPU 101 determines whether the degree of similarity obtained in S803 is equal to or larger than a first threshold. When the degree of similarity is equal to or larger than the first threshold, the flow goes to processing in Step S805. The determination in Step S804 is made in order to avoid the low degree of similarity in which the degree of similarity is not detected because, even in the face images of the same person, one of the face images faces straight while the other face image looks aside. When the degree of similarity is smaller than the first threshold in Step S804, the CPU 101 goes to processing in Step S808. In Step S805, the CPU 101 determines whether the degree of similarity obtained in S803 is equal to or smaller than a second threshold that is larger than the first threshold. When the degree of similarity is equal to or smaller than the second threshold, the flow goes to processing in Step S806. The determination in Step S805 is made in order to avoid the high degree of similarity in which the face images of the same person are clearly retrieved as in identification photograph images facing straight. In performing the retrieve using the person's name of “person A”, displayed face images 902, 903, and 904 correspond to the case of the high degree of similarity.

When the degree of similarity is larger than the second threshold in Step S805, the CPU 101 goes to processing in Step S808.

In Step S806, the CPU 101 determines whether a face orientation in the face image obtained in S803 differs from that of the registered image. When the face orientation in the face image differs from that of the registered image, the flow goes to processing in Step S807. The face image recognition processing in Step S806 can be performed by a well-known face recognition function.

When the face orientation in the face image does not differ from that of the registered image in Step S806, the CPU 101 goes to processing in Step S808. The face image recognition processing in Step S806 can be performed by a well-known face recognition function.

In Step S807, the CPU 101 increments the current pointer of the face image list by one. Then, the flow goes to processing in Step S802. In Step S808, the CPU 101 deletes the face image existing in the current pointer from the face image list, and goes to processing in Step S807.

The above processings are performed to the face images corresponding to all the face IDs stored in the face image list, thereby extracting the image that is of the face image of the same person and has an intermediate degree of similarity. Therefore, the face that is slightly different from the face image already registered in the face dictionary, for example, the face image having a different expression, hairstyle, or face orientation is easily retrieved. The face image is registered in the face dictionary to effectively improve a hit rate of retrieve.

An operation example of a user interface in the case of the use of the face recognition apparatus according to the first embodiment of the invention will be described below.

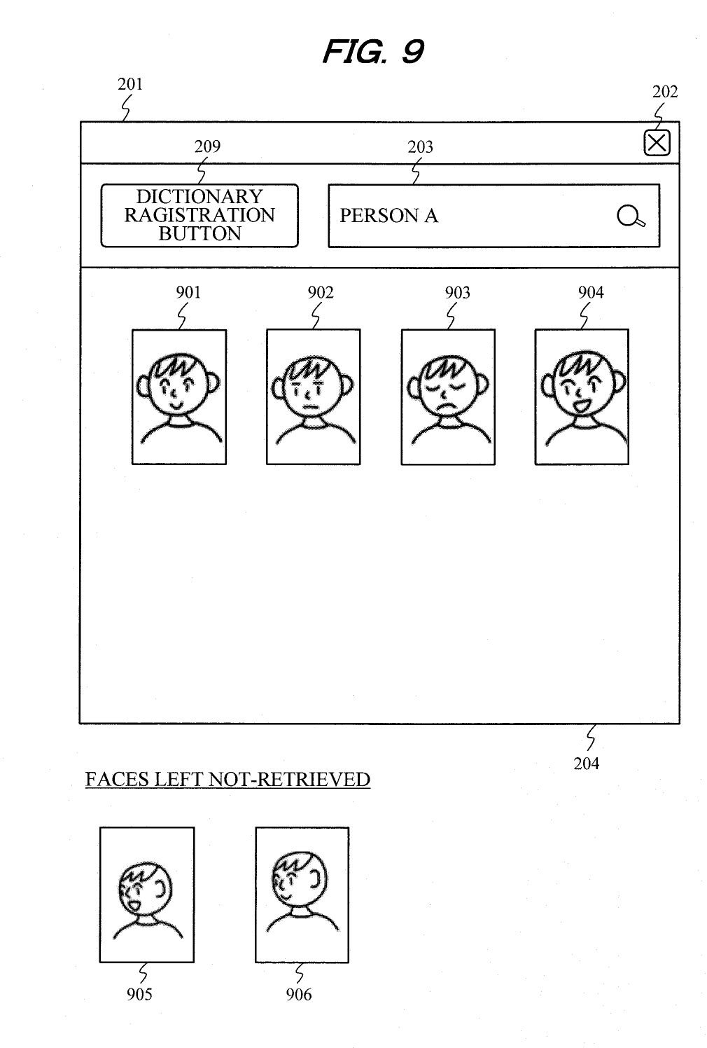

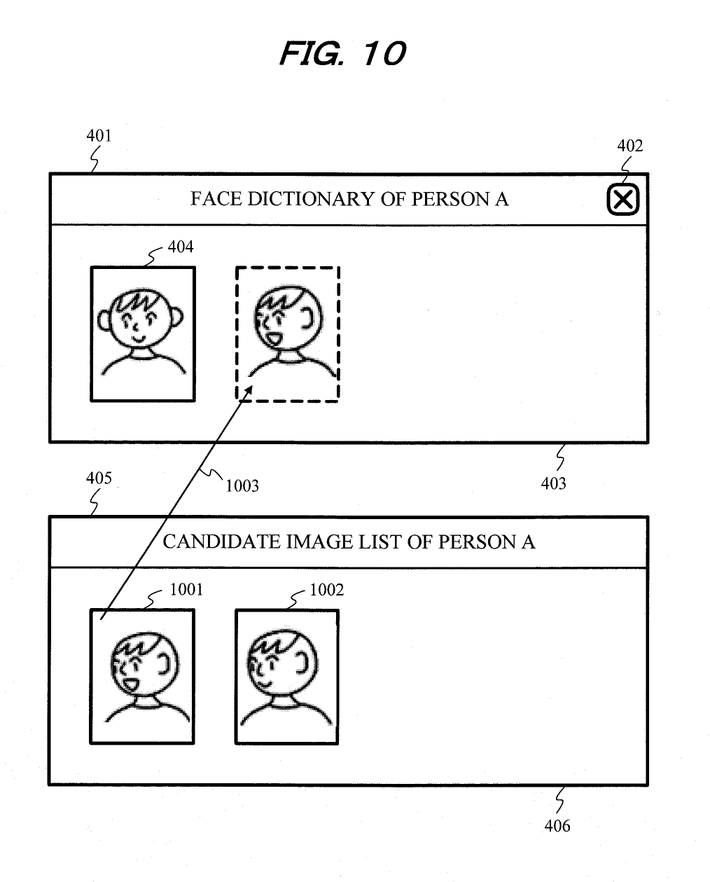

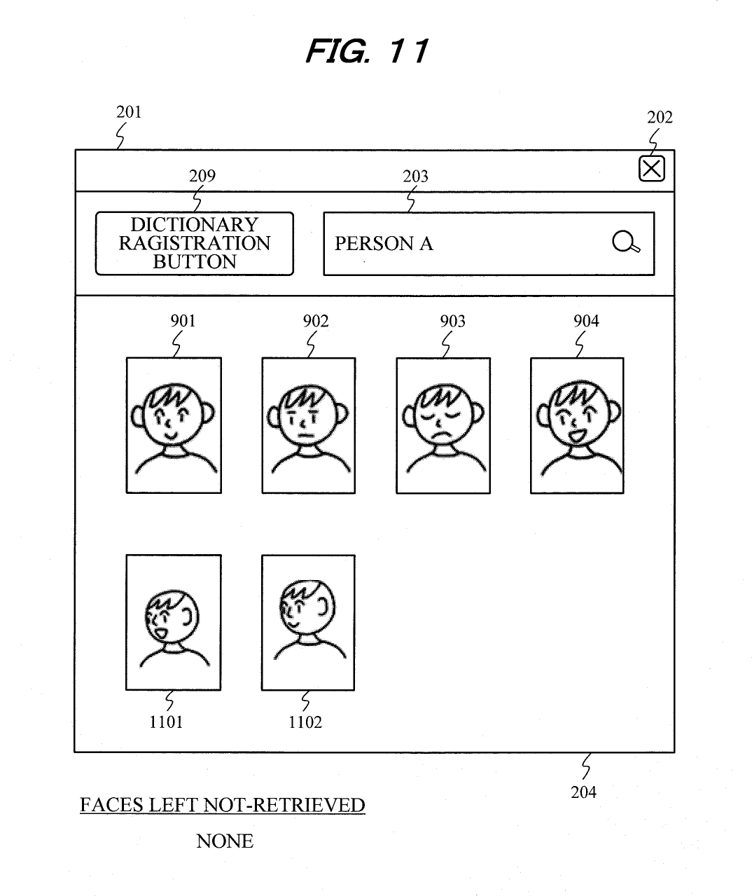

FIG. 9 is a view illustrating an operation example of a face retrieve dialog before face image addition according to the first embodiment of the invention. The basic user interface in FIG. 9 is identical to that in FIG. 2. FIG. 10 is a view illustrating operation examples of the face dictionary dialog 401 and the face candidate image listing dialog 405 according to the first embodiment of the invention. The basic user interface in FIG. 10 is identical to that in FIG. 4. FIG. 11 is a view illustrating an operation example of a face retrieve dialog after the face image addition according to the first embodiment of the invention. The basic user interface in FIG. 11 is identical to that in FIG. 2.

In FIG. 9, the user opens the face retrieve dialog 201 that is of a function of the image browser, and inputs the “person A” as the person's name to the person's name input text box 203. When detecting the input, the CPU 101 displays the face image 901 decided as that of the “person A” from the face dictionary and the face image 902, the face image 903, and the face image 904, which are determined to be similar to the “person A” by the CPU 101 from the HDD 105, on the face image listing display area 204. However, there are face images 905, 906 left not-retrieved on the HDD 105 which are not displayed in the face image listing display area 204. Because, although it is apparent when the user views the images that the “person A” is in the image, the CPU 101 didn't determine the faces of the face images to be similar to that of the “person A”. At this point, it is assumed that the user depresses the dictionary registration button 209, selects the “person A” as the person's name to be subjected to edit of the face dictionary using the face dictionary editing subject person selecting dialog 301 in FIG. 3, and depresses the OK button 304. The CPU 101 then displays the face dictionary dialog and the face candidate image listing dialog in FIG. 10. In displaying the face candidate image listing dialog 406 in FIG. 10, the CPU 101 performs the recognition accuracy improving face image extraction processing to display the list of a face image 1001 and a face image 1002, which are not so similar to the “person A”, on the face candidate image listing display area 406. At this point, the user decides that the face image 1001 which is not so similar to the “person A” is that of that person oneself, and performs a drag and drop 1003 of the face image 1001 to the face dictionary registered image listing display area 403. The CPU 101 registers the face image 1001 selected by the user as the face of the “person A” in the face dictionary.

In other words, the image displayed in the face candidate image listing display area 406 is an image which the face recognition apparatus recommends the user to register in the face dictionary. A retrieve rate of the face of the person can efficiently be enhanced by registering all or some of the images displayed in the face candidate image listing display area 406 in the face dictionary. That is, the images of the subject person can be extracted from many images with the less number of images being left not-retrieved while the number of face images registered in the face dictionary is uselessly increased. A calculation load of the face recognition processing can largely be reduced by decreasing the number of face images registered in the face dictionary as few as possible.

The user returns to the face retrieve dialog 201 in FIG. 11 to retrieve the person's name of the “person A” again using the person's name input text box 203.

In response to the retrieve, the CPU 101 displays the next images in accordance with the updated face dictionary. That is, the CPU 101 displays the face image 901 and the face image 1101 decided as that of the “person A” and the face image 902, the face image 903, and the face image 904, the face image 1102, which are determined to be similar to the “person A” by the CPU 101 from the HDD 105, on the face image listing display area 204. That is, because the face image 1001 can be registered in the face dictionary, the face image 1102 is newly retrieved and displayed in addition to the similar face images 902 to 904 that are retrieved in the past when the person's name of the “person A” is retrieved.

As described above, the face candidate image that efficiently improves the recognition accuracy is displayed when the face recognition apparatus of the embodiment is used. Therefore, the user's trouble with the repetition of the work to select the image to be registered in the face dictionary can be reduced to improve the recognition accuracy to a certain level by the less number of times of operation. Even if the user does not know the characteristic of the face recognition function that the recognition accuracy is efficiently improved by registering the face images of the same person, which are not so similar to each other, in the face dictionary, the recognition accuracy can be improved to a certain level by the less number of times of operation.

The face recognition apparatus can encourage the user to register the feature amount of the face that effectively improves the face recognition rate. On the other hand, the face recognition apparatus can reduce the registration of the feature amount that does not effectively improve the retrieve rate. Thus, advantageously, a consumption amount of the memory or hard disk, which retains the data of the registered face feature amount, can be saved. According to the invention, in retrieving the person, the comparison of the registered image in the face dictionary, which does not contribute to improvement of the recognition rate, with the face feature amount is eliminated, so that the retrieve having the similar recognition rate can be performed at a higher speed.

The recognition accuracy improving face image extraction processing is cited in the first embodiment. In the recognition accuracy improving face image extraction processing of the present embodiment, while the degree of similarity falls within a constant range, the face orientation that differs from that of the face image registered in the face dictionary is used as the face image candidate that efficiently improve the recognition accuracy. However, in one modification of the first embodiment, the feature amount except the face orientation can be used as the determination target. For example, it is conceivable that a direction of a light source in the face image, the face expression, an estimated age, and face components such as a beard are used as the determination target. Each modification will sequentially be described below. A modification in which, while the degree of similarity falls within a constant range, an illumination appearance on the face in the face image (that is, the direction of the light source in the face image) that differs from that of the registered face image is used as the face image candidate that efficiently improves the recognition accuracy will be described below. In the modification, the configuration of the face recognition apparatus is identical to that of the first embodiment.

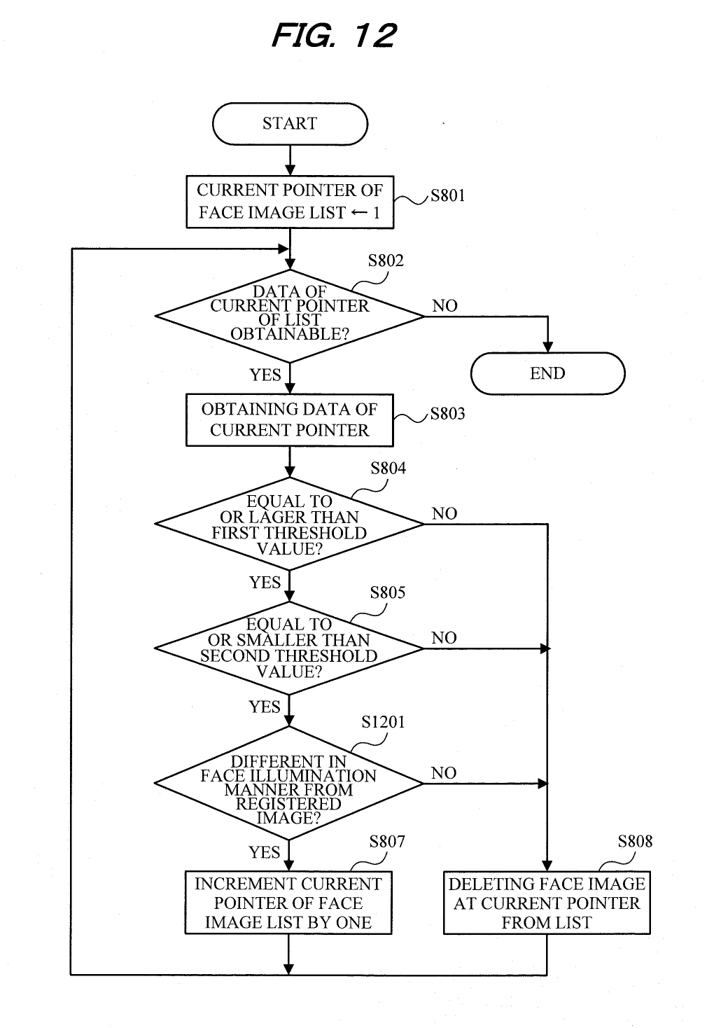

FIG. 12 is a view illustrating a detailed flowchart of recognition accuracy improving face image extraction processing of the modification. The flowchart in FIG. 12 further describes the detail of the processing in Step S705 of the first embodiment.

In FIG. 12, the processings in Steps S801 to S805 and Steps S807 and S808 are identical to those of the first embodiment. In Step S1201, the CPU 101 determines whether the illumination appearance on the face in the face image obtained in Step S803 differs from that of the registered image. When the illumination appearance on the face in the face image differs from that of the registered image, the flow goes to the processing in Step S807. The face image recognition processing in Step S1201 can be performed by a well-known face recognition function.

When the illumination appearance on the face in the face image does not differ from that of the registered image in Step S1201, the CPU 101 goes to the processing in Step S808. As described above, according to the present modification, the face image in which a shadow similar to that of the face image already registered in the face dictionary is not displayed in the face candidate image listing display area 406. Therefore, even if many face images in each of which the shadow exists in the face exist in the HDD 105, the user can save the work to repeatedly register the image in which the similar shadow exists in the face in the face dictionary during the face dictionary registration.

A modification in which, while the degree of similarity falls within a constant range, the face expression that differs from that of the registered face image is used as the face image candidate that efficiently improves the recognition accuracy will be described below. In the present modification, the configuration of the face recognition apparatus is identical to that of the first embodiment.

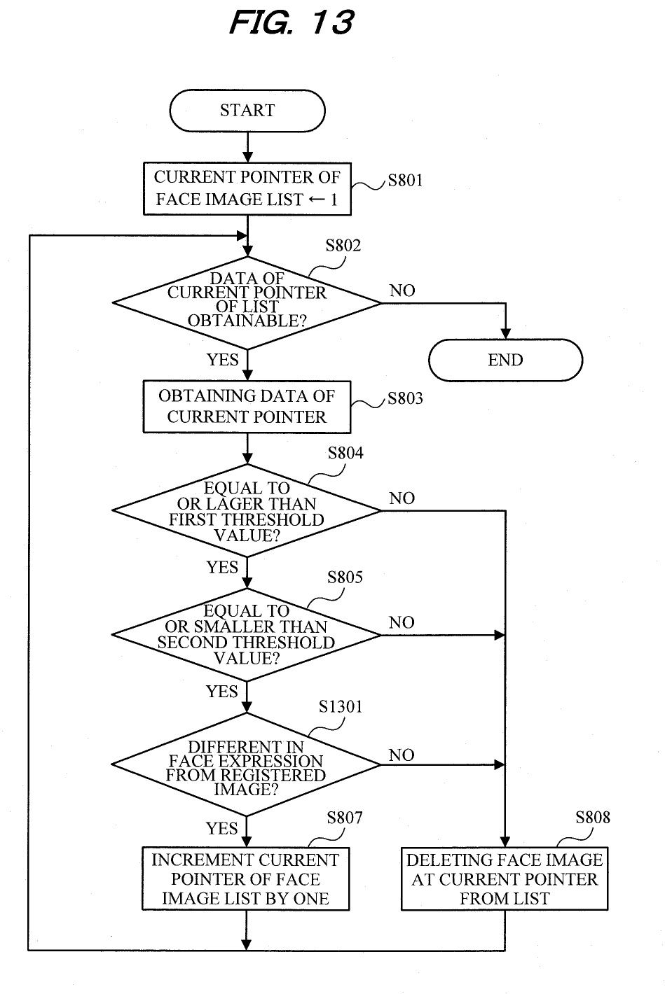

FIG. 13 is a view illustrating a detailed flowchart of recognition accuracy improving face image extraction processing of the modification. The flowchart in FIG. 13 further describes the detail of the processing in Step S705 of the first embodiment. In FIG. 13, the processings in Steps S801 to S805 and Steps S807 and S808 are identical to those of the first embodiment. In Step S1301, the CPU 101 determines whether the face expression of the face image obtained in Step S803 differs from that of the registered image. When the face expression of the face image differs from that of the registered image, the flow goes to the processing in Step S807. The face image recognition processing in Step S1301 can be performed by a well-known face recognition function. When the face expression of the face image does not differ from that of the registered image in Step S1301, the CPU 101 goes to the processing in Step S808.

As described above, according to the present modification, the face image in which the face expression similar to that of the face image already registered in the face dictionary is not displayed in the face candidate image listing display area 406. Therefore, even if many face images in each of which the similar expression exists in the face exist in the HDD 105, the user can save the work to repeatedly register the image in which the similar expression exists in the face in the face dictionary during the face dictionary registration.

A next modification in which, while the degree of similarity falls within a constant range, the estimated age of the person that differs from that of the registered face image is used as the face image candidate that efficiently improves the recognition accuracy will be described below. In the present modification, the configuration of the face recognition apparatus is identical to that of the first embodiment.

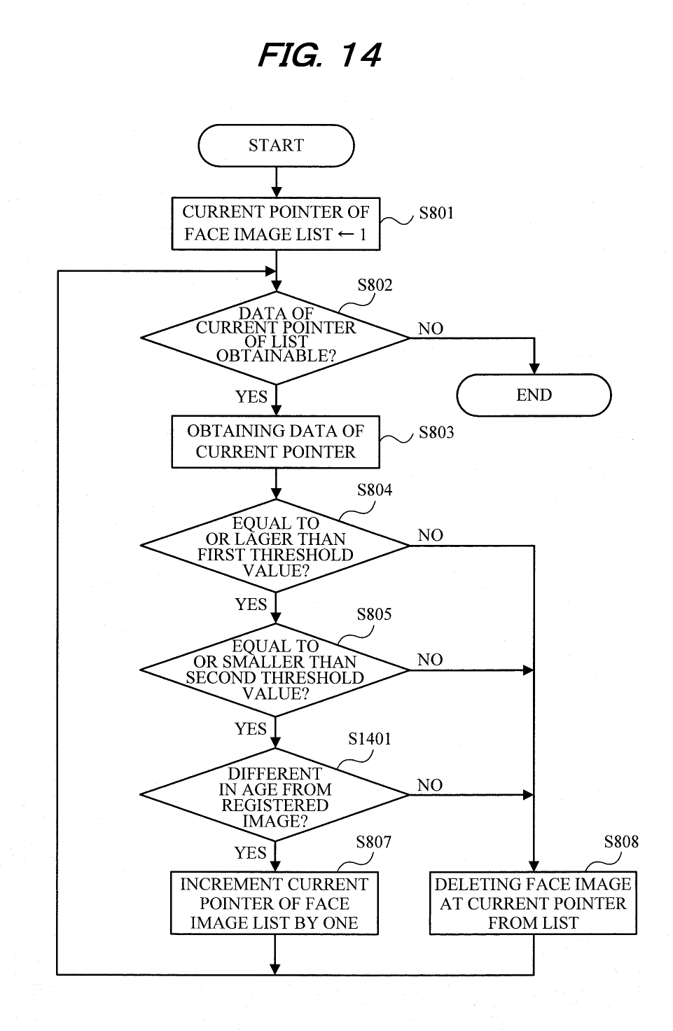

FIG. 14 is a view illustrating a detailed flowchart of recognition accuracy improving face image extraction processing of the modification. The flowchart in FIG. 14 further describes the detail of the processing in Step S705 of the first embodiment. In FIG. 14, the processings in Steps S801 to S805 and Steps S807 and S808 are identical to those of the first embodiment. In Step S1401, the CPU 101 determines whether the estimated age of the subject person in the face image obtained in Step S803 differs from that of the registered image. When the estimated age of the subject person in the face image differs from that of the registered image, the flow goes to the processing in Step S807. The face image recognition processing in Step S1401 can be performed by a well-known face recognition function.

When the estimated age of the subject person in the face image does not differ from that of the registered image in Step S1401, the CPU 101 goes to the processing in Step S808.

As described above, according to the present modification, in the face image of the person already registered in the face dictionary, the image that is determined to be the low degree of similarity due to the influence of the face change of the estimated age is displayed in the face candidate image listing display area 406. Therefore, the user needn't manually search the face image of the same person having the different estimated age from the HDD 105 to register the face image in the face dictionary during the face dictionary registration.

A next modification in which, while the degree of similarity falls within a constant range, the face component that differs from that of the registered face image is used as the face image candidate that efficiently improves the recognition accuracy will be described below. In the present modification, the configuration of the face recognition apparatus is identical to that of the first embodiment.

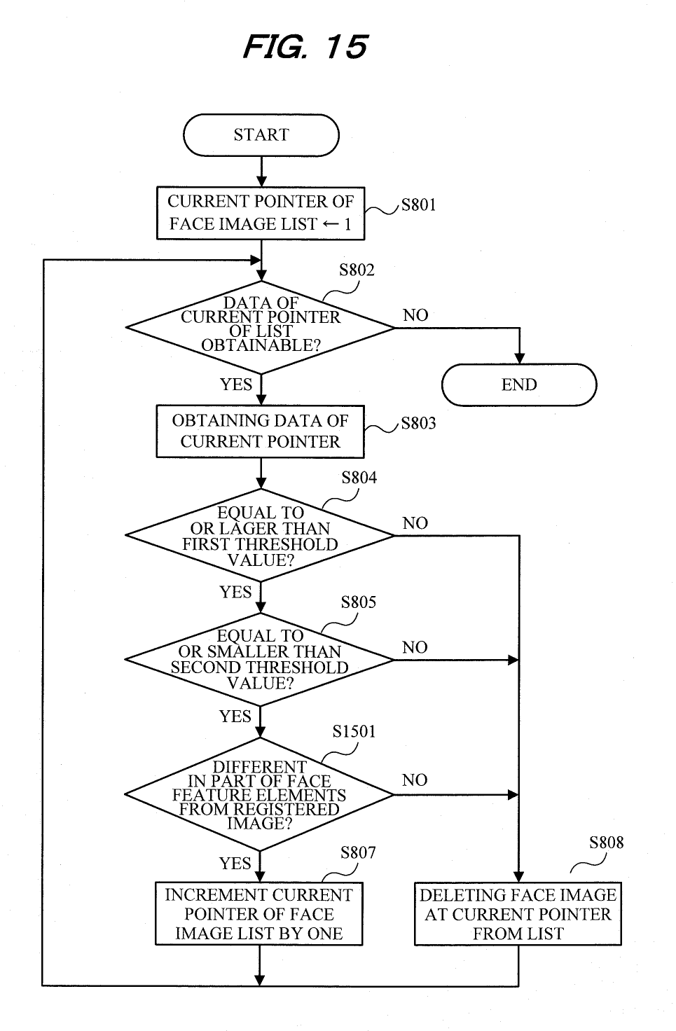

FIG. 15 is a view illustrating a detailed flowchart of recognition accuracy improving face image extraction processing of the fifth modification. The flowchart in FIG. 15 further describes the detail of the processing in Step S705 of the first embodiment. In FIG. 15, the processings in Steps S801 to S805 and Steps S807 and S808 are identical to those of the first embodiment.

In Step S1501, the CPU 101 determines whether the face component in the face image obtained in Step S803 differs from that of the registered image. When the face component in the face image differs from that of the registered image, the flow goes to the processing in Step S807. The face image recognition processing in Step S1501 can be performed by a well-known face recognition function. When the face component in the face image does not differ from that of the registered image in Step S1501, the CPU 101 goes to the processing in Step S808.

As described above, according to the modification, even the face image in which the shape of the beard, eyebrows, or eyelashes is changed compared with that at the time when the face image already registered in the face dictionary is taken is displayed in the face candidate image listing display area 406. Therefore, the user needn't manually search the face image of the same person having the different face component from the HDD 105 to register the face image in the face dictionary during the face dictionary registration.

### Second Embodiment

The recognition accuracy improving face image extraction processing in which, while the degree of similarity falls within a constant range, the face orientation and the like that differ from those of the registered face image are used as the face image candidate that efficiently improves the recognition accuracy is described in the first embodiment.

In a second embodiment, in addition to the face image in which the degree of similarity falls within a constant range is used as the face image candidate that efficiently improves the recognition accuracy, the face image in which the degree of similarity exceeds the second threshold is also used as the face image candidate.

However, although the list of face images in each of which the degree of similarity exceeds the second threshold is displayed on the face candidate image listing dialog, the face image in which the degree of similarity exceeds the second threshold cannot be registered in the face dictionary. In the second embodiment, the configuration of the face recognition apparatus is identical to that of the first embodiment.

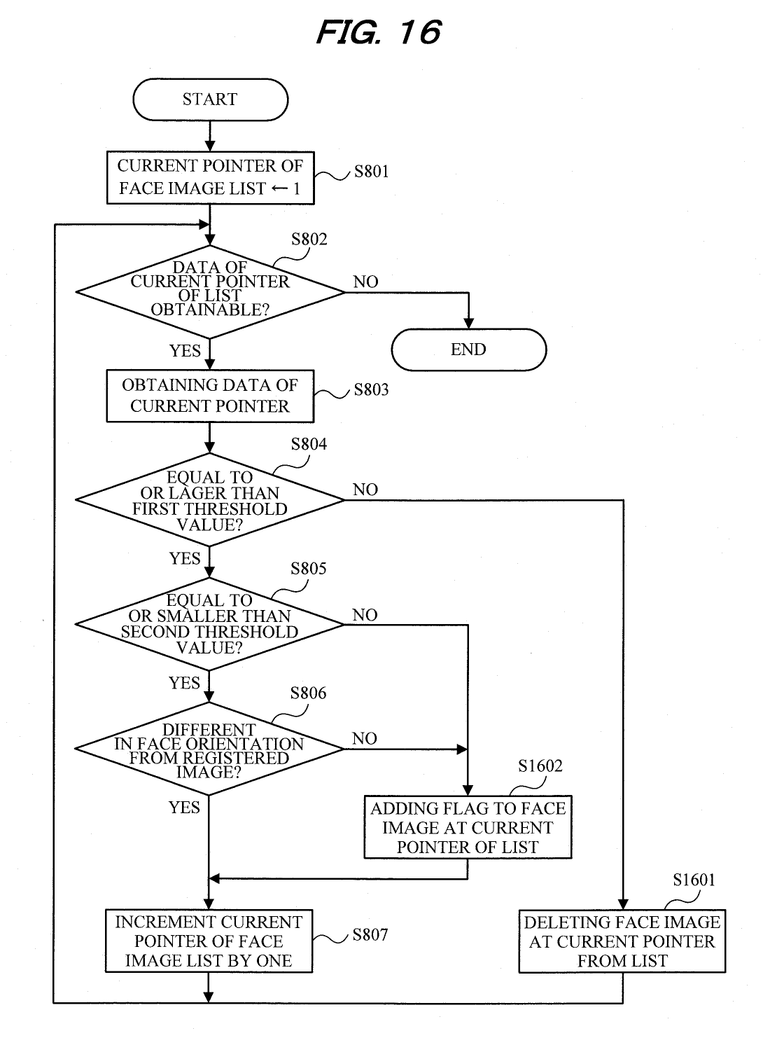

FIG. 16 is a view illustrating a detailed flowchart of recognition accuracy improving face image extraction processing of the second embodiment. The flowchart in FIG. 16 further describes the detail of the processing in Step S705 of the first embodiment. In FIG. 16, the processings in Steps S801 to S803 and Step S807 are identical to those of the first embodiment.

In Step S804, the CPU 101 determines whether the degree of similarity obtained in S803 is equal to or larger than a first threshold. When the degree of similarity is equal to or larger than the first threshold, the CPU 101 goes to the processing in Step S805. When the degree of similarity is smaller than the first threshold, the CPU 101 goes to processing in Step S1601.

In Step S805, the CPU 101 determines whether the degree of similarity obtained in S803 is equal to or smaller than a second threshold. When the degree of similarity is equal to or smaller than the second threshold, the flow goes to processing in Step S806. When the degree of similarity is larger than the second threshold, the CPU 101 goes to processing in Step S1602.

In Step S806, the CPU 101 determines whether the face orientation in the face image obtained in S803 differs from that of the registered image. When the face orientation in the face image differs from that of the registered image, the flow goes to processing in Step S807. When the face orientation in the face image does not differ from that of the registered image, the CPU 101 goes to processing in Step S1602.

In Step S1602, the CPU 101 adds flag information to the face image existing on the current pointer of the list, and goes to the processing in Step S807. In Step S1601, the CPU 101 deletes the face image existing on the current pointer from the face image list, and goes to the processing in Step S802.

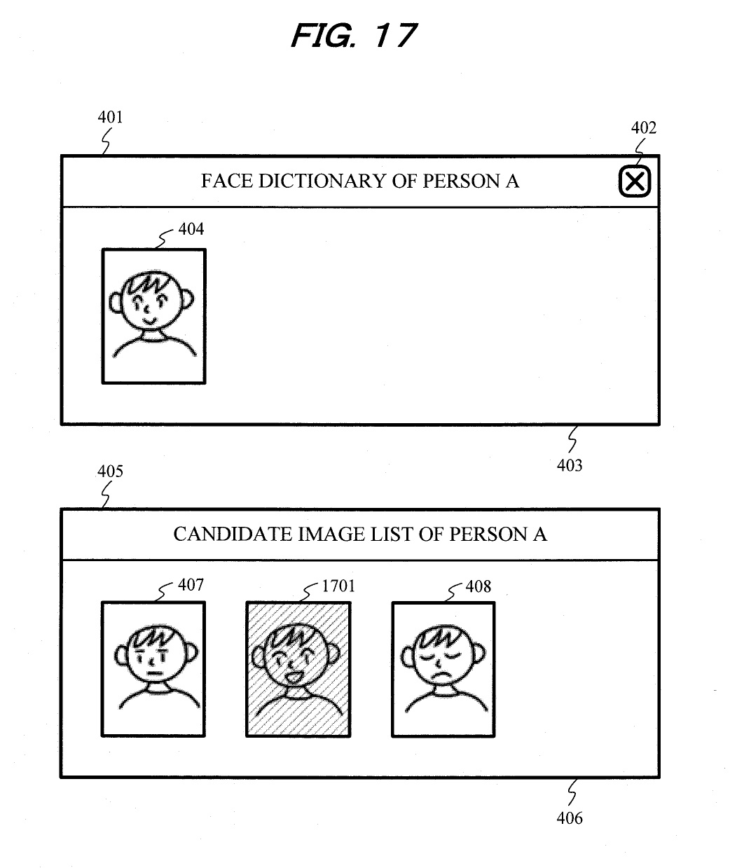

FIG. 17 illustrates the face dictionary dialog 401 and the face candidate image listing dialog 405 in the second embodiment.

When the user depresses the OK button 304 in FIG. 3, the CPU 101 obtains the person's name in the state indicative of selection using the face dictionary editing subject person selecting list box 303, and closes the face dictionary editing subject person selecting dialog. The CPU 101 displays the face dictionary dialog 401 and the face candidate image listing dialog 405, which correspond to the obtained person's name. At this point, the CPU 101 performs the face dictionary registration face image candidate listing display processing in FIG. 7. In the second embodiment, in Step S705, the face image in which a specific condition is satisfied while the degree of similarity falls within a constant range and the face image in which the degree of similarity exceeds the second threshold are extracted. In Step S706, the CPU 101 displays the face image in which the specific condition is satisfied while the degree of similarity falls within the constant range and the face image in which the degree of similarity exceeds the second threshold, in the face candidate image listing display area 406 side by side.

When the user selects the face image in which the degree of similarity exceeds the second threshold, using the mouse to drag and drop the face image in which the degree of similarity exceeds the second threshold to the face dictionary registered image listing display area, the CPU 101 determines whether the flag information is added to the face image selected by the user. When the flag information is added to the face image selected by the user, the CPU 101 does not register the face image selected by the user in the face dictionary even if the user completes the drag and drop operation. When the flag information is not added to the face image selected by the user, the CPU 101 registers the face image selected by the user in the face dictionary in response to the completion of the drag and drop operation of the user. When the face images in each of which the degree of similarity exceeds the second threshold are displayed side by side in the face candidate image listing display area 406, in order to inform the user of the face image that cannot be registered in the face dictionary, the CPU 101 may translucently display the face image in which the degree of similarity exceeds the second threshold. Instead of displaying translucently the face image in which the degree of similarity exceeds the second threshold, a frame color of the face image may be changed, or an icon or a mark, which indicates that the face image cannot be registered in the face dictionary, may be displayed.

In the second embodiment, the face orientation is cited as the specific condition. Instead of the face orientation, the face expression, the illumination appearance on the face in the face image, the age, and the change of the face component may be used as the specific condition.

As described above, when the face recognition apparatus of the present embodiment is used, the face candidate image that efficiently improves the recognition accuracy is presented to the user, and the face candidate image that has the extremely high degree of similarity while not efficiently improving the recognition accuracy is also presented to the user. Therefore, the user can visually recognize the face image that is determined to be the person oneself in the wide range of degree of similarity. When the face recognition apparatus of the embodiment is used, the list of face candidate images that efficiently improve the recognition accuracy and face candidate images that have the extremely high degree of similarity while not efficiently improving the recognition accuracy can be displayed in a mixing manner. Because the face candidate image having the extremely high degree of similarity cannot be registered in the face dictionary, the user can improve the recognition accuracy to a certain level with the less number of times of operation when repeatedly performing the person deciding work.

When the face recognition apparatus of the present embodiment is used, while the list of face candidate images that efficiently improve the recognition accuracy and face candidate images that have the extremely high degree of similarity while not efficiently improving the recognition accuracy is displayed in the mixing manner, the user is notified of the information on the face image that cannot be registered in the face dictionary. Therefore, the user can visually recognize which image is the face candidate image that efficiently improves the recognition accuracy during the person deciding work.

In the second embodiment, in addition to the face candidate image that efficiently improves the recognition accuracy, the face candidate image having the extremely high degree of similarity is presented to the user in the mixing manner. A modification of display control (FIG. 17) will be described below.

In the present modification, the face candidate image that efficiently improves the recognition accuracy is preferentially displayed at the head in the face candidate image listing display area 406, and the face candidate image having the extremely high degree of similarity is displayed in the lower position in the face candidate image listing display area 406 while a priority is lowered. In the modification, the configuration of the face recognition apparatus is identical to that of the second embodiment.

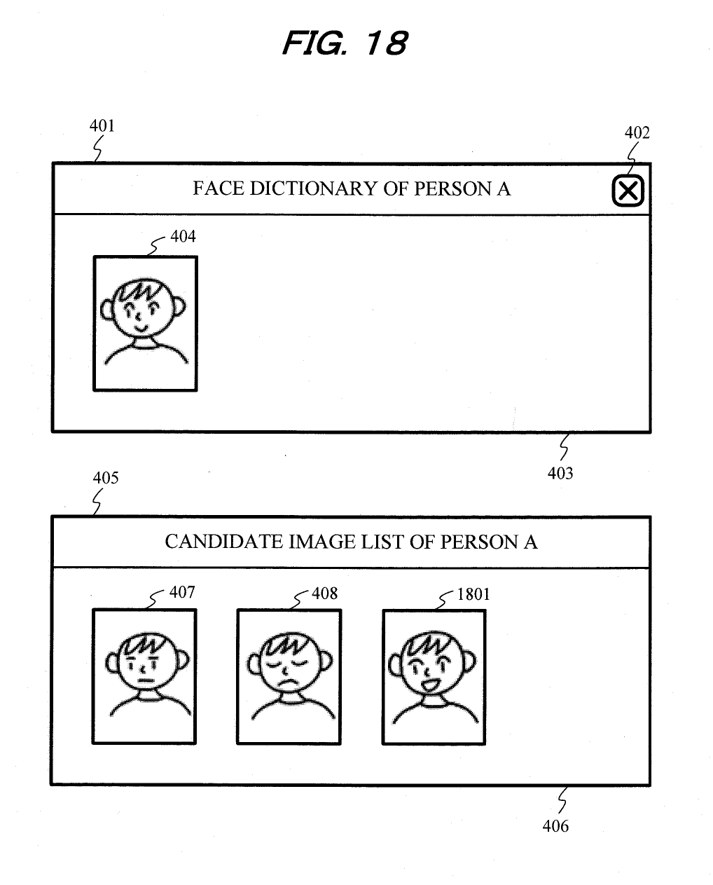

FIG. 18 is a view illustrating the face dictionary dialog 401 and the face candidate image listing dialog 405 in the present modification.

When the user depresses the OK button 304 in FIG. 3, the CPU 101 obtains the person's name in the state indicative of selection using the face dictionary editing subject person selecting list box 303, and closes the face dictionary editing subject person selecting dialog. The CPU 101 displays the face dictionary dialog 401 and the face candidate image listing dialog 405, which correspond to the obtained person's name. At this point, the CPU 101 performs the face dictionary registration face image candidate listing display processing in FIG. 7. In the second embodiment, in Step S705, the face image in which the specific condition is satisfied while the degree of similarity falls within the constant range and the face image in which the degree of similarity exceeds the second threshold are extracted. In Step S706, the CPU 101 displays the face image in which the specific condition is satisfied while the degree of similarity falls within the constant range and the face image in which the degree of similarity exceeds the second threshold, in the face candidate image listing display area 406 side by side.

At this point, the CPU 101 determines whether the flag information is added to the face image extracted in Step S705. When the flag information is not added to the face image, the CPU 101 preferentially displays the face image at the head of the list of face images in the face candidate image listing display area 406. When the flag information is added to the face image extracted in Step S705, the CPU 101 displays the face image in the lower portion of the list of face images in the face candidate image listing display area 406 while lowering the priority.

In the present modification, similarly to the modification of the first embodiment, the face orientation is cited as the specific condition. However, instead of the face orientation, the face expression, the illumination appearance on the face in the face image, the estimated age, and the change of the face component may be used as the specific condition.

As described above, when the face recognition apparatus of the present embodiment is used, the face candidate image that efficiently improves the recognition accuracy can be presented to the user. Because the face candidate image that has the extremely high degree of similarity while not efficiently improving the recognition accuracy can also be presented to the user, the user can visually recognize the face image that is determined to be the person oneself in the wide range of degree of similarity.

When the face recognition apparatus of the present embodiment is used, the face candidate image that efficiently improves the recognition accuracy is displayed at the head of the list of face images in the face candidate image listing display area, and the face candidate image that has the extremely high degree of similarity while not efficiently improving the recognition accuracy is displayed in the lower portion of the list of face images in the face candidate image listing display area. Therefore, the recognition accuracy can efficiently be improved, as the user registers the initially-presented face image while being not aware of the face candidate image that efficiently improves the recognition accuracy.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2011-109412, filed on May 16, 2011, which is hereby incorporated by reference herein in its entirety.

What is claimed is:

1. A face recognition apparatus comprising:
a feature amount extraction unit configured to extract a face feature amount by analyzing a face image of a person in a picture image;
a face dictionary generation unit configured to generate a face dictionary while relating the feature amount extracted by the feature amount extraction unit to a person's name;
an addition unit configured to newly add a face feature amount while relating the face feature amount to a person's name registered in the face dictionary; and
a display control unit configured to calculate a degree of similarity by comparing the face feature amount, which is extracted by analyzing the face image of the person in another picture image, with the face feature amount registered in the face dictionary, and to display the face image in which the degree of similarity falls within a predetermined range, as a candidate to be added to the face dictionary on a display portion.

2. The face recognition apparatus according to claim 1, wherein the predetermined range does not include a range where the calculated degree of similarity indicates the high degree of similarity and a range where the calculated degree of similarity indicates the low degree of similarity.

3. The face recognition apparatus according to claim 1, wherein the display control unit determines whether a face orientation of the extracted face image in which the calculated degree of similarity falls within the predetermined range differs from a face orientation registered in the face dictionary, and the display control unit displays the face image in which the face orientation differs from the face orientation registered in the face dictionary, as the additional candidate when an affirmative determination is made.

4. The face recognition apparatus according to claim 1, wherein the display control unit determines whether a direction of a light source with respect to the face image in which the calculated degree of similarity falls within the predetermined range differs from a direction of a light source with respect to a face image registered in the face dictionary, and the display control unit displays the face image in which the direction of the light source differs from that of the face image registered in the face dictionary, as the additional candidate when an affirmative determination is made.

5. The face recognition apparatus according to claim 1, wherein the display control unit determines whether a face expression of the face image in which the calculated degree of similarity falls within the predetermined range differs from a face expression of a face image registered in the face dictionary, and the display control unit displays the face image in which the face expression differs from that of the face image registered in the face dictionary, as the additional candidate when an affirmative determination is made.

6. The face recognition apparatus according to claim 1, wherein the display control unit determines whether an estimated age of a face in a face image in which the calculated degree of similarity falls within the predetermined range differs from an estimated age of a face in a face image registered in the face dictionary, and the display control unit displays the face image in which the estimated age of the face differs from that of the face image registered in the face dictionary, as the additional candidate when an affirmative determination is made.

7. The face recognition apparatus according to claim 1, wherein the display control unit determines whether at least one face component in a face image in which the calculated degree of similarity falls within the predetermined range differs from differs from a face component of a face image registered in the face dictionary, and the display control unit displays the face image in which the face component differs from that of the face image registered in the face dictionary, as the additional candidate when an affirmative determination is made.

8. The face recognition apparatus according to claim 2, wherein the display control unit arranges the face image in which the calculated degree of similarity falls within the high degree of similarity, at a position after the face image of the candidate to be added.

9. The face recognition apparatus according to claim 8, wherein, when the face image in which the calculated degree of similarity falls within the high degree of similarity is displayed along with the candidate to be added, the addition unit effects control such that the face image in which the calculated degree of similarity falls within the high degree of similarity cannot be registered in the face dictionary.

10. A face recognition apparatus controlling method comprising:
a feature amount extraction step of extracting a face feature amount by analyzing a face image of a person in a picture image;
a face dictionary generation step of generating a face dictionary while relating the feature amount extracted in the feature amount extraction step to a person's name;
an addition step of newly adding a face feature amount while relating the face feature amount to a person's name registered in the face dictionary; and
a display control step of calculating a degree of similarity by comparing the face feature amount, which is extracted by analyzing the face image of the person in another picture image, with the face feature amount registered in the face dictionary, and of displaying the face image in which the degree of similarity falls within a predetermined range, as a candidate to be added to the face dictionary on a display portion.

11. A computer-readable recording medium in which a program causing a computer to perform the controlling method according to claim 10 is recorded.
